(19) United States
(12) Patent Application Publication
(10) Pub. No.: US 2026/0298433 A1
(43) Pub. Date: Oct. 1, 2026

(54) VEHICLE LIGHT AND LIGHT SYSTEM WITH DECORATIVE LIGHTING FEATURE

(71) Applicant: YourTruckShop Inc., Laval (CA)

(72) Inventors: David Merovitz, Cote Saint Luc (CA); Mitchell Robert Magonet, Cote Saint Luc (CA)

(21) Appl. No.: 19/629,280

(22) Filed: Mar. 26, 2026

Related U.S. Application Data
(60) Provisional application No. 63/777,816, filed on Mar. 26, 2025.

(51) Int. Cl. F21S 43/14; B60Q 1/30; B60Q 1/44; F21S 43/20; F21S 43/31

(52) U.S. Cl. CPC F21S 43/14; B60Q 1/30; B60Q 1/44; F21S 43/2641; F21S 43/31

(57) ABSTRACT

A lighting system with a lighting device is provided where the lighting device is adapted to be installed on a vehicle and has dual functionality, namely providing an operation functionality for safety and/or communication (for example operating as a headlight, taillight, brake light, turn signal, hazard light, fog light, running light, marker light, etc. or a combination of the foregoing) and providing a decorative lighting or other non-operational lighting functionality.

### CROSS-REFERENCE TO RELATED APPLICATION

This application claims priority from U.S. provisional patent application No. 63/777,816, filed Mar. 26, 2025, entitled “VEHICLE LIGHT AND LIGHT SYSTEM WITH DECORATIVE LIGHTING FEATURE”, which is incorporated herein in its entirety.

### TECHNICAL FIELD

The present disclosure relates to vehicle accessories, and more particularly to vehicle lights and lighting accessories.

### BACKGROUND

After-market lights and lighting accessories for use with vehicles using public roads are often required to meet certain regulatory requirements for public road use, thereby imposing limitations on their configuration, such as their dimensions, size, colour, brightness, etc. As such, these limitations can restrict certain functionalities that may be offered by these lights and lighting accessories.

It would be advantageous to develop certain lighting devices for use with vehicles that can offer additional functionalities for vehicle operators while still meeting regulatory requirements for public road use.

### SUMMARY OF INVENTION

The present disclosure relates to lighting devices for vehicles for safety and communication (for example headlights, taillights, brake lights, turn signals, hazard lights, fog lights, running lights, marker lights etc.) which may be required to meet certain regulations for use on the vehicle on a public road while also having the ability to function as ornamental and/or decorative lights (“decorative lighting”) or provide other lighting functionality.

The lighting device defines a first light source and a second light source. The first light source is configured to be actuated to provide at least one operation functionality for safety and/or communication (for example operating as a headlight, taillight, brake light, turn signal, hazard light, fog light, running light, etc. or a combination of the foregoing) and the second light source is configured to be actuated to provide at least one decorative or other non-operational lighting functionality.

One aspect of the invention provides a lighting device for a vehicle comprising a housing; a first light source that emits light from the lighting device to signal at least one operation functionality of the vehicle; a second light source that emits light from the lighting device to provide decorative lighting or other non-operational functionality; a first connector connected to the first light source to receive inputs to actuate the first light source in accordance with at least one operation functionality of the vehicle; a second connector connected to the second light source to receive inputs from a controller to actuate the second light source. The lighting device may further comprise a first lens wherein at least some of the light from the first light source is emitted from the device through the first lens and at least some of the light from the second light source is emitted from the device through the first lens. The at least one operation functionality may be any one of operating as a headlight, a taillight, a brake light, a turn signal, a hazard light, a fog light or a running light. The second light source may provide decorative lighting and may emit light in multiple colours.

In other embodiments, the first and/or second light source comprises at least one LED and the lighting device may also comprise at least one reflector positioned to redirect at least some of the light emitted by the at least one LED of the first and/or second light source. The first and/or second light source may also comprise multiple LEDs and the lighting device may further comprise multiple reflectors positioned to redirect at least some of the light emitted by at least one of the multiple LEDs of the first and/or second light source.

In further embodiments, first light source can emit light at a first luminosity level and a second luminosity level, wherein the second luminosity level is greater than the first luminosity level. The lighting device may also be a taillight and the first light source emits red light at a first luminosity level to signal that the vehicle is running and emits red light at the second luminosity level to signal that the vehicle is breaking. The first light source may also emit red light at the second luminosity level intermittently to signal that a turn signal in the vehicle has been activated.

In yet a further embodiment, the lighting device further comprises a second lens facing a direction opposite to the first lens and wherein at least some of the light from the first light source is emitted from the device through the second lens and at least some of the light from the second light source is emitted from the device through the second lens. The light from the first light source emitted through the first lens may also be a first colour, for example amber, and the light from the first light source emitted through the second lens may be a second colour, for example red.

Another aspect of the invention provides a lighting system for a vehicle comprising at least one lighting device of the type referenced above and a controller. A lighting system may also comprise at least two lighting devices of the type referenced above to be connected in at least two zones of the vehicle and wherein the controller is adapted to actuate the second light source of the one or more lighting devices located in one zone of the vehicle independently of the second light source of the one or more lighting devices in the other zones. The lighting system may also be adapted to prevent light from being emitted from the second lighting source of the at least two lighting devices unless the vehicle is in park

### BRIEF DESCRIPTION OF THE DRAWINGS

The invention will be better understood by way of the following detailed description of embodiments of the invention with reference to the appended drawings, in which:

FIG. 1A is a front perspective view of an exemplary lighting device in accordance with the present teachings;

FIG. 1B is a back perspective view of the exemplary lighting device of FIG. 1A;

FIG. 2A is a front view of another exemplary lighting device in accordance with the present teachings;

FIG. 2B is a back view of the exemplary lighting device of FIG. 2A;

FIG. 3A is a front view of another exemplary lighting device in accordance with the present teachings;

FIG. 3B is a back view of the exemplary lighting device of FIG. 3A;

FIG. 4A is a front view of another exemplary lighting device in accordance with the present teachings;

FIG. 4B is a side view of the exemplary lighting device of FIG. 4A;

FIG. 5 is a side perspective view of another exemplary lighting device in accordance with the present teachings;

FIG. 6 is a schematic of a controller system in accordance with the present teachings;

FIG. 7 is a side view of a tractor illustrating exemplary zones of lighting devices in accordance with the present teachings;

FIG. 8A is a front view of an exemplary wiring harness in accordance with the present teachings; and

FIG. 8B is a front view of the exemplary wiring harness of FIG. 8A.

### DETAILED DESCRIPTION

The present disclosure relates to a lighting system that includes one or more lighting devices that are adapted to be installed on a vehicle and have dual functionality of providing an operation functionality for safety and/or communication (for example operating as a headlight, taillight, brake light, turn signal, hazard light, fog light, running light, marker light, etc. or a combination of the foregoing) and to provide decorative lighting or other lighting functionality.

The lighting device is connectable to the vehicle through connectors that permit the lighting device to receive inputs corresponding to the state of operation of the vehicle (headlight on/off, taillight or running light on/off, brakes being applied, turn signal activated, hazard light being activated, fog light being activated, vehicle is operating, etc.) to control the light being emitted from a first light source as well as receiving inputs from a controller to control the light being emitted from a second light source which provides decorative lighting or other lighting functionality.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

### Definitions

In the present disclosure, “vehicle” includes a motor vehicle (e.g. gas-powered, electric-powered, etc.) which may be used for transportation on land (e.g. roads, off-roading). Vehicles include a trailer or other device that may be towed by a motor vehicle. Exemplary vehicles include, but are not limited to, cars, trucks, tractors, trailers, four-by-fours, etc.

### Exemplary Lightning Devices

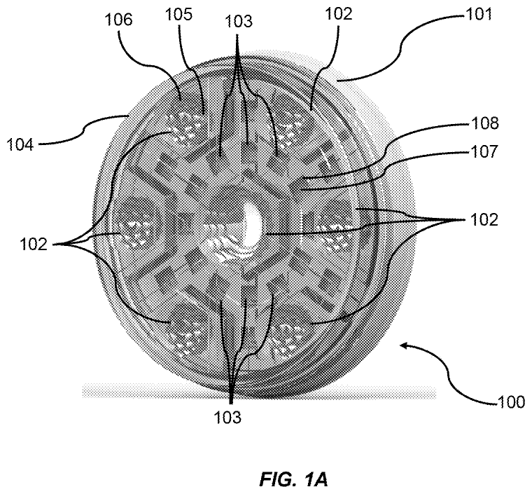

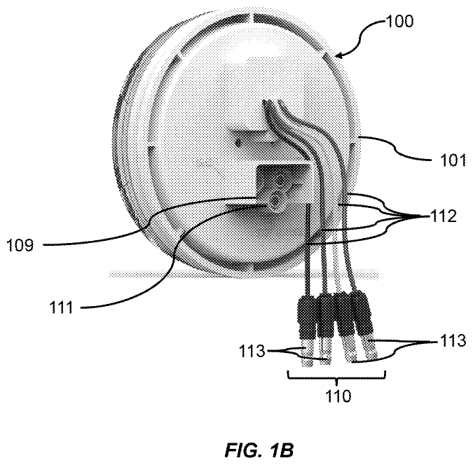

Reference is made to FIG. 1A & B illustrating an exemplary lighting device 100 in accordance with the present teachings. The lighting device 100 may comprise a housing 101, a first light source 102, a second light source 103, and a lens 104. The lens 104 is transparent or translucent to permit light emitted from the first light source and the second light source to pass therethrough.

The first light source 102 may comprise of one or more LEDs 105. Each of the one or more LEDs 105 may have a reflector 106 surrounding the LED to redirect and focus at least some of the light of emitted by the LED. The reflector 106 may have a conical or frustoconical shape, with the LED 105 positioned at the center thereof. In the embodiment shown in FIG. 1A, the first light source 102 comprises six LEDs 105 each with corresponding reflectors 106 positioned in a circle at equal radial distance from the center of the lighting device and a seventh LED 105 with a reflector 106 positioned in the center of the lighting device.

The first light source 102 is adapted to emit light through lens 104 to communicate a state of operation of the vehicle (headlight on/off, taillight and/or running light on/off, brakes being applied, turn signal activated, hazard light being activated, fog light being activated, vehicle is operating, etc.) in a colour and luminosity that may comply with certain regulatory requirements. The light emitted from the first light source 102 may also be steady or intermittent. For example, the lighting device 100 may be designed to operate as a taillight where the first light source 102 emits light in the colour red at a desired luminosity level to indicate that the vehicle is operating. Alternatively, the lighting device 100 may be designed to operate as a brake light where the first light source 102 emits light in the colour red at a desired luminosity level when the brake of the vehicle is applied. In a further alternative, the lighting device 100 may be designed to operate as a turn signal where the first light source 102 emits light in the colour red intermittently at a desired luminosity level when the turn signal of the vehicle is activated. In yet a further alternative, the lighting devices 100 may be designed to communicate multiple states of operation of the vehicle. For example, the first light source 102 may emit light in the colour red at a first luminosity level to indicate that the vehicle is operating, in the colour red at a second luminosity level that is greater than the first luminosity level when the brake of the vehicle is applied and intermittently in red between the first luminosity level and the second luminosity level when the turn signal is activated. The operation of the first light source is controlled by inputs received by the lighting device from the vehicle as discussed in greater detail below.

The second light source 103 may comprise of one or more LEDs 107 which may be positioned within a square recess 108. The square recess may be provided with one or more reflectors (not shown) to focus the light of produced by the LED 107. In the embodiment shown in FIG. 1A, the second light source 103 comprises 18 LEDs 107 each positioned within a square recess 108.

The second light source 103 is adapted to emit light through lens 104 to provide decorative lighting or other lighting functionality. For example, the second light source 103 may be designed to emit light in a single colour (for example blue) or in multiple colours (for example red, green and blue). In an embodiment where the second light source 103 emits light in multiple colours, a single LED 107 may be provided in recess 108 that emits light in multiple colours or, alternatively multiple LEDs 107 may be provided within recess 108, each adapted to emit light in a different colour. In addition, the second light source 103 may have multiple LEDS 107 adapted to emit light at different colours such that multiple colours can be emitted through lens 104 at the same time.

As shown in FIG. 1B, the lighting device 100 may include a first connector assembly 109 and a second connector assembly 110 to receive inputs to control the operation of the first light source 102 and the second light source 103 respectively. The first connector assembly 109 may comprise a plurality of female connectors 111 adapted to receive male connectors from a vehicle control system such that inputs can be received to control the operation of the first light source 102 in accordance with a state of operation of the vehicle. The first connector may be a universal PL3 connector of the type shown in FIG. 1B. The second connector assembly 110 may comprise a plurality of wires 112 with male connectors 113 to connect to a light control system such that inputs can be received to control the operation of the second light source 103. In the embodiment shown in FIG. 1B, the second connector assembly 110 comprises four wires 112 with male connectors 113. Three of the wires 112 are to receive an input from a light control system to emit a light of a different colour from the second light source 103 (for example a first wire receives input for the colour red, a second wire receives input for the colour green and a third wire receives input for the colour blue) and the fourth wire is for connecting to a ground. The wires 112 may have a colour scheme that identifies the wire, for example the first wire is coloured red, the second wire is coloured green, the third wire is coloured blue and the fourth wire is coloured black.

The housing 101 contains and may protect the different components of the lighting device 100. The sides of the housing 101 may be adapted for insertion into a cavity on the vehicle. For example, the housing 101 shown in FIGS. 1A and 1B may be adapted to be used with a grommet mount to be maintained within the cavity or may be provided with a flange (not shown) extending around some or all of the periphery adapted to engage with a fastener (for example screws) to secure the housing into the cavity of the vehicle. The housing 101 may be made from plastic, from metal, or other suitable material.

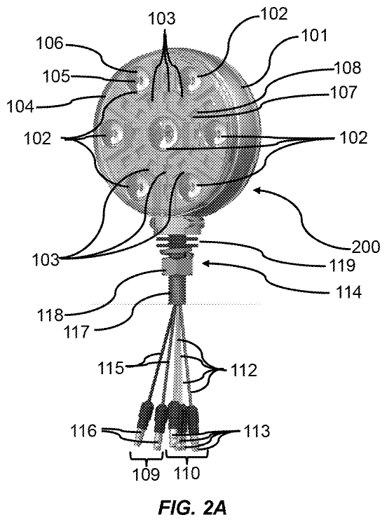

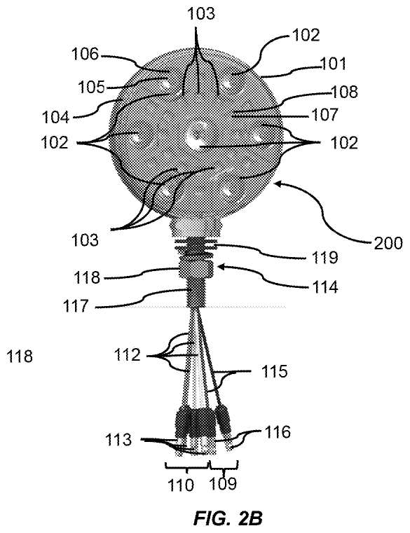

Reference is made to FIGS. 2A and 2B illustrating another exemplary lighting device 200 in accordance with the present teachings. Elements of the lighting device 200 that are similar to the elements of the lighting device 100 are identified with the same numbering as shown in FIGS. 1A and 1B.

As with the embodiment shown in FIGS. 1A and 1B, the lighting device 200 can operate as a running light, a brake light, a turn signal light or may be designed to communicate multiple states of operation of the vehicle. The lighting device 200 may comprise a first light source 102 and second light source 103 on both the front and back so that it can communicate states of operation on the vehicle in two directions. The first light source 102 on the front of the lighting device may emit light in a first colour and the first light source 102 on the back of the lighting device 200 may emit light in a second colour. For example, the first light source 102 on the front of the lighting device 100 may emit light that is amber in colour and the first light source 102 on the back of the lighting device 100 may emit light that is red in colour.

The lighting device 200 further includes connector assembly 114 for connecting the lighting device to a portion of the vehicle (for example a wheel fender) such that the front of the lighting device is facing forward, and the back of the lighting device is facing backwards. As shown, the connector assembly 114 may include an externally threaded tube 117, a nut 118 and washers 119 to secure the light device 200 to the vehicle in a clamping arrangement by rotating the nut 118 to move the nut axially along the threaded tube 117.

The first connector assembly 109 of the lighting device 200 may comprise a pair of wires 115 with male connectors 116 extending through the threaded tube 117. The male connectors 116 are adapted to be inserted into female connectors attached to the vehicle control system such that inputs can be received by the lighting device 200 to control the operation of the first light source 102 on both the front and the back of the lighting device 200 in accordance with a state of operation of the vehicle. The wires 112 of the second connector assembly 110 may also extend through the threaded tube 117 as shown in FIGS. 2A and 2B.

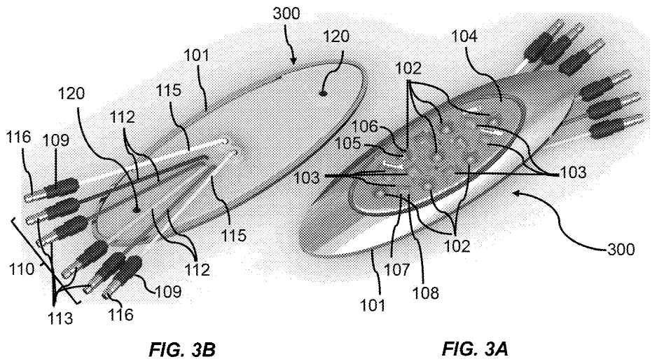

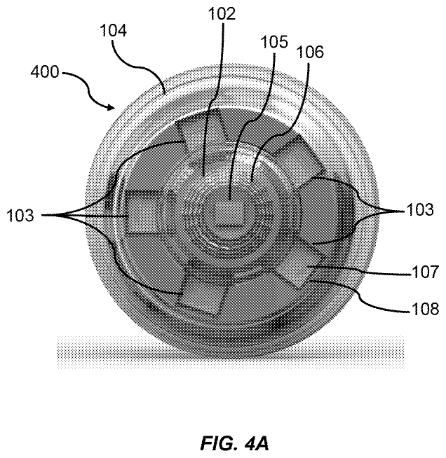

Reference is made to FIGS. 3A and 3B illustrating yet another exemplary lighting device 300 in accordance with the present teachings. Elements of the lighting device 300 that are similar to the elements of the lighting devices in the earlier embodiments are identified with the same numbering as shown in FIGS. 1A, 1B, 2A and 2B.

The lighting device 300 may be used as a marker light to identify the perimeter of the vehicle when the vehicle is in operation. As shown in FIG. 3B, the lighting device 300 includes holes 120 in the back surface thereof which provides for insertion of a screw or similar device to secure the lighting device 300 to the vehicle.

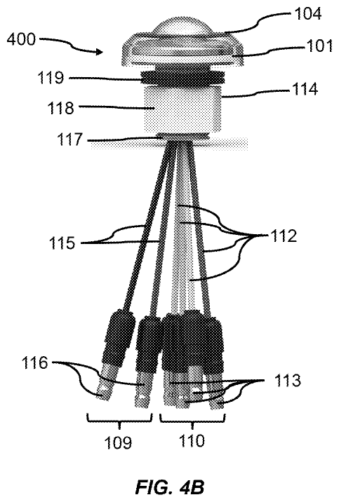

Reference is made to FIGS. 4A and 4B illustrating yet another exemplary lighting device 400 in accordance with the present teachings. Elements of the lighting device 400 that are similar to the elements of the lighting devices in the earlier embodiments are identified with the same numbering as shown in FIGS. 1A, 1B, 2A, 2B, 3A and 3B.

The lighting device 400 may also be used as a marker light to identify the perimeter of the vehicle when the vehicle is in operation. As shown in FIG. 4A, the first light source 102 of lighting device 400 may comprise a single LED 105 surrounded by a reflector 106 with the second light source 103 of five LEDs 107 in square recesses 108 equally spaced in a circle around the single LED 105.

As shown in FIG. 4B, the lighting device 400 may also include a connector assembly 114 that may comprise of an externally threaded tube 117, a nut 118 and washers 119 to secure the lighting device 100 to the vehicle in a clamping arrangement similar to the embodiment shown in FIGS. 2A and 2B.

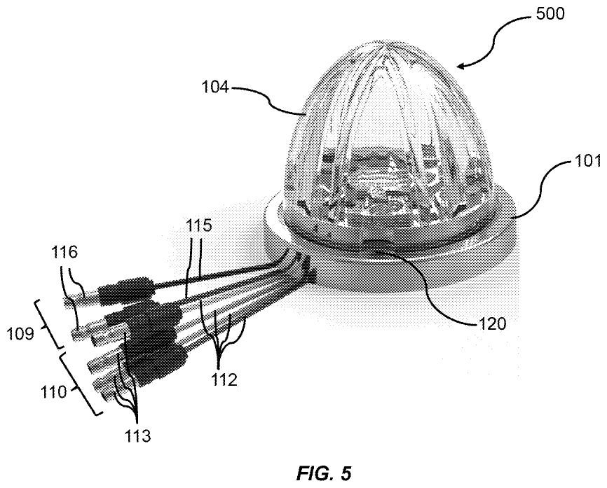

Reference is made to FIG. 5 illustrating a further exemplary lighting device 500 in accordance with the present teachings. Elements of the lighting device 500 that are similar to the elements of the lighting devices in the earlier embodiments are identified with the same numbering as shown in FIGS. 1A, 1B, 2A, 2B, 3A, 3B, 4A and 4B.

The embodiment shown in FIG. 5 can operate as a running light, a brake light, a turn signal light or may be designed to communicate multiple states of operation of the vehicle. Although not shown, the lighting device 500 has a first light source 102 comprising seven LEDs 105 surrounded by a reflector 106 (one LED 105 in the center and six LEDs 105 equally spaced in a circle around the center LED similar to the lighting devices 100 and 200). The second light source comprises twelve LEDs 107 in square recesses 108 (two LEDs 107 positioned between each of the six LEDs 105 arranged in a circle). The embodiment shown in FIG. 5 may include holes 120 for securing the light to the vehicle using screws or other suitable fasteners.

### Exemplary Light Control System

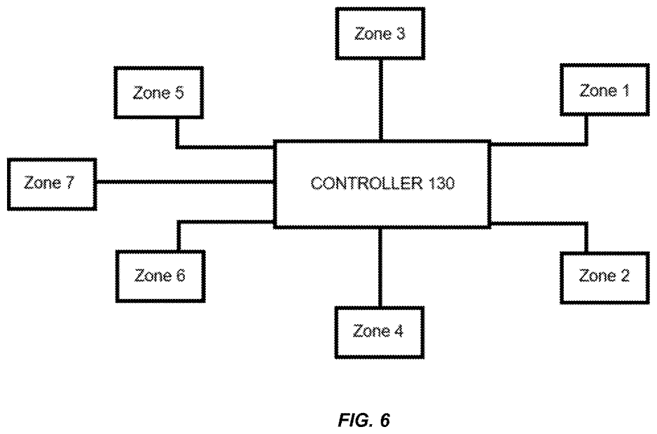

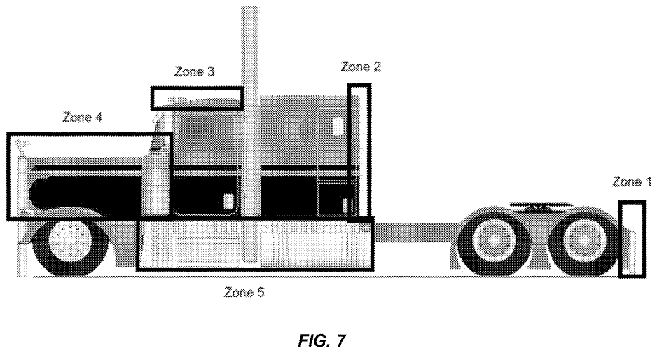

As shown in FIG. 6, the second light source 103 of lighting devices 100, 200, 300, 400 and/or 500 on a vehicle may be controlled by a controller 130. In the embodiment shown in FIG. 6, lighting devices in accordance with the present teachings are connected to the vehicle in one of seven zones, namely zones 1 to 7, with the lighting devices in each zone being connected to the controller 130. The zones can be allocated in any suitable manner around the vehicle. One possible arrangement for a tractor of a semi-truck is shown in FIG. 7 with zone 1 comprising the lighting devices on the back of the chassis, zone 2 comprising the lighting devices on the back of the cab, zone 3 comprising the lighting devices on the roof, zone 4 comprising the lighting devices on the driver side front fender section, zone 5 comprising the lighting devices on the driver side lower cab section, zone 6 comprising the lighting devices on the passenger side front fender section (not shown but corresponds to zone 4 on driver side) and zone 7 comprising the lighting devices on the passenger side lower cab section (not shown but corresponds to zone 5 on driver side). It is understood that the number of zones and the allocation of each of the zones to the lighting devices on different parts of the vehicle may be varied without departing from the invention.

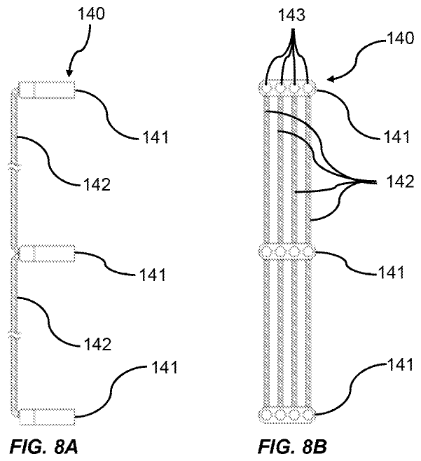

The lighting devices in a zone may be connected to the controller 130 using a wire harness 140 of the type shown in FIGS. 8A and 8B. The wire harness 140 comprised a plurality of connector assemblies 141 connected to each other by harness wires 142. Each of the connector assemblies 141 may have four female connectors 143, each electrically connected to one of the harness wires 142. The female connectors 143 are adapted to receive male connectors 113 of the second connector assembly 110 of the lighting devices. The harness wires 142 may have a colour scheme to simplify connection to the corresponding male connectors 113 of the lighting device. For example, the connector assemblies 141, the harness wires 142 and/or the female connectors 143 may be coloured red, green, blue, and black, to correspond to the colour scheme of the wires 112 of the lighting device as referenced above.

The controller 130 sends inputs to each of the zones to illuminate the LEDs 107 of the second light source 103 of the lighting devices within that zone. The input can be to emit light having a particular lighting effect, including to emit a particular colour of light, to emit a particular combination of colours of light, to emit light a particular intensity, to emit a solid light, to emit a flashing or strobing light, to emit a light that fades on or off, or a combination of the foregoing. The controller 130 may have a remote control for controlling the operation of the lighting devices. Alternatively, the controller 130 may have a Bluetooth™ connection to connect to a smart phone or other wireless device to operate the controller 130 through an app or program. The controller 130 may also include a safety switch which prevents light from being emitted from the second light source 103 of the lighting devices on the vehicle unless the vehicle is in a parked state so that light cannot be emitted therefrom while the vehicle is in operation or in motion. The controller 130 may have a general power switch to turn power on or off for the entire system. The controller 130 may have a separate power switch for each zone to selectively turn power on or off to that particular zone without altering the power state of the other zones. For each of the zones, the controller 130 may be provided with connectors for connecting to the controller 130 to the corresponding male connectors 113 of the lighting devices within that zone. For the lighting devices 100, 200, 300, 400 and/or 500, the controller may have four connectors for each zone and those connectors may be coloured red, green, blue, and black, to correspond to the colour scheme of the wires 112 of the lighting device and/or harness wires 142 of the wire harness 140 as referenced above. For example, for each zone, the controller 130 may have four male connectors that are coloured red, green, blue, and black to be inserted in the corresponding female connectors 143 in one of the connector assemblies 141 of wire harness 140.

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

1. A lighting device for a vehicle, comprising:
a housing;
a first light source that emits light from the lighting device to signal at least one operation functionality of the vehicle;
a second light source that emits light from the lighting device to provide decorative lighting or other non-operational functionality;
a first connector connected to the first light source to receive inputs to actuate the first light source in accordance with at least one operation functionality of the vehicle;
a second connector connected to the second light source to receive inputs from a controller to actuate the second light source.

2. A lighting device as claimed in claim 1 further comprising a first lens wherein at least some of the light from the first light source is emitted from the device through the first lens and at least some of the light from the second light source is emitted from the device through the first lens.

3. A lighting device as claimed in claim 2 wherein the second light source provides decorative lighting and can emit light in multiple colours.

4. A lighting device as claimed in claim 2 wherein the second light source comprises at least one LED.

5. A lighting device as claimed in claim 4 further comprising at least one reflector positioned to redirect at least some of the light emitted by the at least one LED.

6. A lighting device as claimed in claim 5 wherein the second light source comprises multiple LEDs and further comprising multiple reflectors positioned to redirect at least some of the light emitted by at least one of the multiple LEDs.

7. A lighting device as claimed in claim 2 wherein the first light source comprises at least one LED.

8. A lighting device as claimed in claim 7 further comprising at least one reflector positioned to redirect at least some of the light emitted by the at least one LED.

9. A lighting device as claimed in claim 8 wherein the first light source comprises multiple LEDs and further comprising multiple reflectors positioned to redirect at least some of the light emitted by at least one of the multiple LEDs.

10. A lighting device as claimed in claim 9 wherein the at least one operation functionality is any one of operating as a headlight, a tail light, a brake light, a turn signal, a hazard light, a fog light or a running light.

11. A lighting device as claimed in claim 7 wherein the first light source can emit light at a first luminosity level and a second luminosity level, wherein the second luminosity level is greater than the first luminosity level.

12. A lighting device as claimed in claim 11 wherein the lighting device is a taillight and the first light source emits red light at a first luminosity level to signal that the vehicle is running and emits red light at the second luminosity level to signal that the vehicle is breaking.

13. A lighting device as claimed in claim 12 wherein the first light source emits red light at the second luminosity level intermittently to signal that a turn signal in the vehicle has been activated.

14. A lighting device as claimed in claim 7 further comprising a second lens facing a direction opposite to the first lens and wherein at least some of the light from the first light source is emitted from the device through the second lens and at least some of the light from the second light source is emitted from the device through the second lens.

15. A lighting device as claimed in claim 14 wherein the light from the first light source emitted through the first lens is a first colour and the light from the first light source emitted through the second lens is a second colour.

16. A lighting device as claimed in claim 15 wherein the first colour is amber and the second colour is red.

17. A lighting system for a vehicle, comprising:
at least one lighting device of the type claimed in claim 1; and
a controller.

18. A lighting system for a vehicle as claimed in claim 17 further comprising at least two lighting devices of the type claimed in claim 1 to be connected in at least two zones of the vehicle wherein the controller is adapted to actuate the second light source of the one or more lighting devices located in one zone of the vehicle independently of the second light source of the one or more lighting devices in the other zones.

19. A lighting system for a vehicle as claimed in claim 18 wherein the system is adapted to prevent light from being emitted from the second lighting source unless the vehicle is in park.
